(19) United States
(12) Patent Application Publication
(10) Pub. No.: US 2022/0326031 A1
(43) Pub. Date: Oct. 13, 2022

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventors: Shigeo Ohnogi, Nagoya-shi (JP); Shiro Koga, Nagoya-shi (JP); Daiki Kaneichi, Tokyo (JP); Yusuke Omura, Nagoya-shi (JP)

(73) Assignee: TOYOTA JIDOSHA KABUSHIKI KAISHA, Toyota-shi (JP)

(21) Appl. No.: 17/671,121

(22) Filed: Feb. 14, 2022

(30) Foreign Application Priority Data
Apr. 13, 2021 (JP) 2021-067675

(51) Int. Cl. G01C 21/36; G01C 21/34; H04W 4/02; H04W 4/40; G06F 16/2457

(52) U.S. Cl. CPC G01C 21/3617; G01C 21/3461; G01C 21/3484; G01C 21/3492; H04W 4/025; H04W 4/40; G06F 16/24575

(57) ABSTRACT

An information processing device acquires vehicle information including position information of a vehicle and state information of the vehicle. Further, the information processing device identifies an actual position where a wheelchair user has a record of boarding or exiting the vehicle based on the vehicle information. Then, the information processing device adds information on the actual position to a database.

### CROSS-REFERENCE TO RELATED APPLICATION

This application claims priority to Japanese Patent Application No. 2021-067675 filed on Apr. 13, 2021, incorporated herein by reference in its entirety.

### BACKGROUND

### 1. Technical Field

The present disclosure relates to an information processing device and an information processing method.

### 2. Description of Related Art

Japanese Unexamined Patent Application Publication No. 2003-240592 (JP 2003-240592 A) discloses a navigation system for wheelchair users. In the navigation system described in JP 2003-240592 A, a route through which a wheelchair has passed is identified by repeatedly measuring the position of the wheelchair during passage. In addition, the identified wheelchair route is overwritten on the map registered in the database. An accessibility map for wheelchair users is automatically generated based on this map.

### SUMMARY

An object of the present disclosure is to provide a technique capable of improving the convenience for wheelchair users to board or exit a vehicle.

An information processing device according to a first aspect of the present disclosure includes a control unit that executes: acquisition of vehicle information including position information of a vehicle and state information of the vehicle; identification of an actual position where a wheelchair user has a record of boarding or exiting the vehicle based on the vehicle information; and addition of information on the actual position to a database.

An information processing device according to a second aspect of the present disclosure includes: a database that stores information on a plurality of actual positions where a wheelchair user has a record of boarding or exiting a vehicle; and a control unit. The control unit acquires information on a desired boarding position or a desired exiting position of a first wheelchair user, and selects a boarding position or an exiting position to be proposed to the first wheelchair user from the actual positions stored in the database based on the desired boarding position or the desired exiting position.

An information processing method according to a third aspect of the present disclosure is an information processing method executed by a computer, and includes: acquiring information on a desired boarding position or a desired exiting position of a first wheelchair user; and selecting a boarding position or an exiting position to be proposed to the first wheelchair user from a plurality of actual positions where a wheelchair user has a record of boarding or exiting a vehicle that is stored in a database based on the desired boarding position and the desired exiting position.

The aspects of the present disclosure may include an information processing method, an information processing system, a program, and a non-transitory storage medium in which the program is stored that have the same characteristics as the information processing device described above.

According to the present disclosure, it is possible to improve the convenience for wheelchair users to board or exit a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of an information management system according to a first embodiment;

FIG. 2 is a diagram showing an example of a table configuration of vehicle information;

FIG. 3 is a block diagram schematically showing an example of the functional configuration of a management server;

FIG. 4 is a diagram showing an example of a table configuration of an actual position database;

FIG. 5 is a flowchart showing a flow of processing executed for updating the actual position database;

FIG. 6 is a diagram showing another example of a table configuration of the vehicle information;

FIG. 7 is a diagram showing a schematic configuration of an information management system according to a second embodiment;

FIG. 8 is a flowchart showing a flow of processes executed to propose a boarding position to a first wheelchair user;

FIG. 9 is a diagram showing a schematic configuration of an information management system according to a modification of the second embodiment;

FIG. 10 is a flowchart showing a flow of processes executed to propose an exiting position to the first wheelchair user;

FIG. 11 is a diagram showing a modification of a table configuration of the actual position database; and

FIG. 12 is a diagram showing another modification of a table configuration of the actual position database.

### DETAILED DESCRIPTION OF EMBODIMENTS

In general, when a wheelchair user (a user who uses a wheelchair) boards a vehicle, it tends to take longer than when a user who can walk by himself or herself boards the vehicle. Further, it is also necessary to stop the vehicle that the wheelchair user intends to board at a place suitable for the wheelchair to travel. These situations are the same when the wheelchair user exits the vehicle. Therefore, there may be a case where, even at a place where the user who can walk by himself or herself can board or exit the vehicle, it is difficult for the wheelchair user to board or exit the vehicle at that place. That is, it is assumed that the suitable places for wheelchair users to board or exit the vehicle are limited to some extent.

Therefore, an information processing device according to a first aspect of the present disclosure generates a database of positions suitable for the wheelchair user to board or exit the vehicle. An information processing device according to a first aspect of the present disclosure includes a control unit. The control unit acquires vehicle information including position information of a vehicle and state information of the vehicle. Here, the state information of the vehicle includes information related to the state of the vehicle when the wheelchair user boards or exits the vehicle.

Further, the control unit identifies an actual position where the wheelchair user has a record of boarding or exiting the vehicle based on the vehicle information. That is, the control unit identifies the position of the vehicle when the state of the vehicle indicates a state in which the wheelchair user boards or exits the vehicle as the actual position. Further, the control unit adds information on the identified actual position to a database. This makes it possible to generate a database of the actual position where the wheelchair user has a record of boarding or exiting the vehicle, that is, suitable positions for the wheelchair user to board or exit the vehicle. The wheelchair user can understand a suitable position for boarding or exiting the vehicle using the information stored in the database.

Further, an information processing device according to a second aspect of the present disclosure determines a boarding position or an exiting position to be proposed to a first wheelchair user who desires to board or exit the vehicle. The information processing device according to the second aspect of the present disclosure includes a database and a control unit. Here, the database stores information on a plurality of actual positions where the wheelchair user has a record of boarding or exiting the vehicle.

Further, the control unit acquires information on the desired boarding position or the desired exiting position of the first wheelchair user. Here, the desired boarding position is a position where the first wheelchair user who intends to board the vehicle desires to board the vehicle. The desired exiting position is a position where the first wheelchair user who is on board the vehicle desires to exit from the vehicle. Then, the control unit selects a boarding position or an exiting position to be proposed to the first wheelchair user from the actual positions stored in the database based on the desired boarding position or the desired exiting position of the first wheelchair user. With this configuration, the boarding position suitable for the first wheelchair user to board the vehicle or the exiting position suitable for the first wheelchair user to exit the vehicle can be proposed to the first wheelchair user.

Hereinafter, embodiments of the present disclosure will be described below with reference to the drawings. Unless otherwise specified, dimensions, materials, shapes, relative arrangements, and the like of components described in the present embodiments are not intended to limit the technical scope of the present disclosure to those alone.

### First Embodiment

### System Configuration

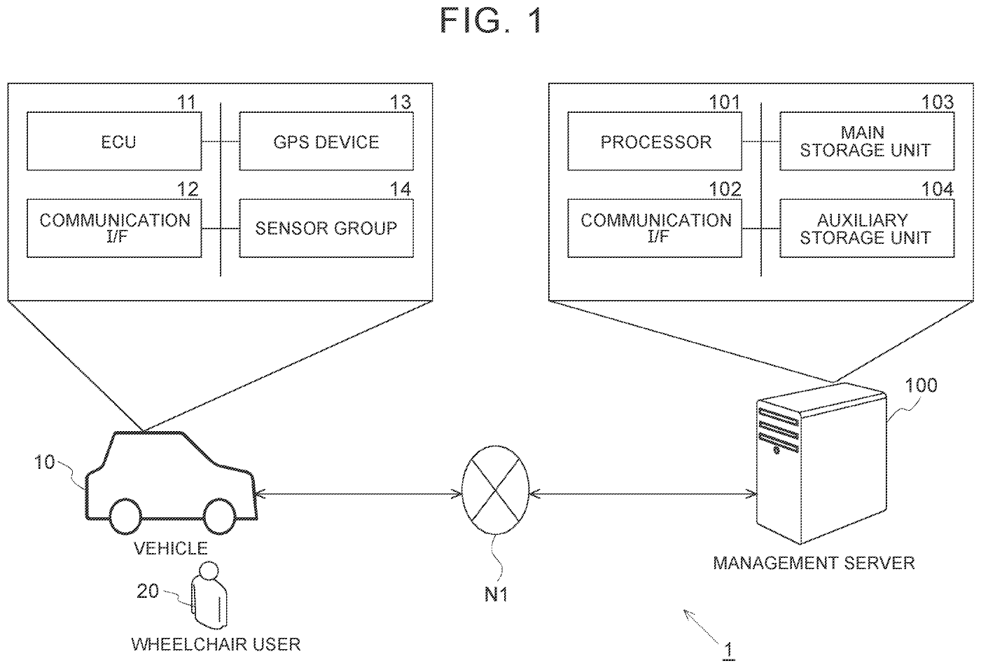

FIG. 1 is a diagram showing a schematic configuration of an information management system according to the present embodiment. An information management system 1 is a system that generates a database of positions suitable for a wheelchair user to board or exit a vehicle.

In the information management system 1, a management server 100 is connected to a vehicle 10 via a network N1. Here, as the network N1, for example, a wide area network (WAN) that is a world-wide public communication network such as the Internet, or a communication network for a telephone such as a cellar phone may be adopted. The vehicle 10 is a vehicle used by a wheelchair user 20. The vehicle 10 may be, for example, a universal design (UD) taxi. Further, a plurality of the vehicles 10 may be connected to the management server 100 via the network N1.

An electronic control unit (ECU) 11, a communication interface (communication I/F) 12, a global positioning system (GPS) device 13, and a sensor group 14 are mounted on the vehicle 10. The ECU 11 is a computer for controlling the vehicle 10. The communication I/F 12 is an interface for performing wireless communication with the management server 100 via the network N1 in accordance with a predetermined wireless communication standard. As the predetermined wireless communication standard, the third generation (3G), Long Term Evolution (LTE), or the fifth generation (5G) can be exemplified. The communication I/F 12 is configured to include a wireless communication circuit for wireless communication.

The GPS device 13 is a device that acquires current position information of the vehicle 10 based on a signal from the GPS satellite and outputs a signal representing the current position information. The sensor group 14 is composed of various sensors installed in the vehicle 10 to detect the state of the vehicle 10. The sensor group 14 includes, for example, a speed sensor, a shift position sensor, and a door sensor. The speed sensor is a sensor that detects the speed of the vehicle 10. The shift position sensor is a sensor that detects the position of the shift lever in the vehicle 10. The door sensor is a sensor that detects an open or closed state of the door in the vehicle 10.

In the vehicle 10, communication is performed among the ECU 11, the communication I/F 12, the GPS device 13, and the sensor group 14 via an in-vehicle network. In the in-vehicle network, communication is performed using a predetermined in-vehicle communication standard. As the predetermined in-vehicle communication standard, controller area network (CAN) or local interconnect network (LIN) can be exemplified. Then, the current position information of the vehicle 10 output from the GPS device 13 is input to the ECU 11. Further, a detection value of each sensor included in the sensor group 14 is input to the ECU 11. Further, the ECU 11 generates vehicle information based on the information input from the GPS device 13 and the sensor group 14. Then, the ECU 11 transmits the generated vehicle information to the management server 100 using the communication I/F 12. The ECU 11 periodically transmits the vehicle information to the management server 100 at predetermined intervals (for example, 1-minute intervals, 5-minute intervals, or 10-minute intervals).

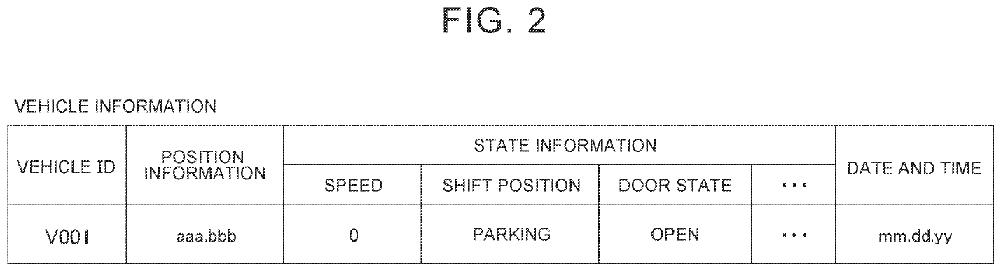

FIG. 2 is a diagram showing an example of a table configuration of vehicle information transmitted from the vehicle 10 to the management server 100. As shown in FIG. 2, the vehicle information includes a vehicle identification (ID) field, a position information field, a state information field, and a date and time field. A vehicle ID that is identification information for identifying the vehicle 10 is input to the vehicle ID field. The current position information of the vehicle 10 acquired from the GPS device 13 is input to the position information field. Information related to the state of the vehicle 10 acquired from the sensor group 14 is input to the state information field. Specifically, information related to the speed of the vehicle 10, the position of the shift lever in the vehicle 10, the open or closed state (door state) of the door in the vehicle 10, and the like is input to the state information field. Information related to the date and time when the position information and the state information are acquired is entered to the date and time field.

Further, the management server 100 is configured to include a general computer. A computer constituting the management server 100 includes a processor 101, a communication interface (communication I/F) 102, a main storage unit 103, and an auxiliary storage unit 104.

Here, the processor 101 is, for example, a central processing unit (CPU) or a digital signal processor (DSP). The communication I/F 102 is an interface for performing wireless communication via the network N1 in accordance with a predetermined wireless communication standard similar to the communication I/F 12 of the vehicle 10. The communication I/F 102 is, for example, a local area network (LAN) interface board or a wireless communication circuit for wireless communication. The main storage unit 103 is, for example, a random access memory (RAM). The auxiliary storage unit 104 is, for example, a read-only memory (ROM), a hard disk drive (HDD), or a flash memory. Further, the auxiliary storage unit 104 may include a removable medium (portable recording medium). Here, the removable medium is, for example, a universal serial bus (USB) memory, a secure digital (SD) card, or a disc recording medium such as a compact disc read-only memory (CD-ROM), a digital versatile disc (DVD), or a Blu-ray disc.

The auxiliary storage unit 104 stores an operating system (OS), various programs, various information tables, and the like. Then, the processor 101 loads a program stored in the auxiliary storage unit 104 into the main storage unit 103 and executes the program, whereby a process of generating a database and a process of providing information that will be described later are realized. However, some or all of the functions in the management server 100 may be implemented by a hardware circuit such as an application specific integrated circuit (ASIC) or a field programmable gate array (FPGA). However, the management server 100 may not be necessarily realized by a single physical configuration, and may be configured by a plurality of computers that cooperates with each other.

The management server 100 receives the vehicle information transmitted from the vehicle 10. Then, the management server 100 identifies an actual position where the wheelchair user 20 has a record of boarding or exiting the vehicle 10 based on the received vehicle information. Further, the management server 100 generates a database of actual positions by accumulating information on the identified actual positions.

### Functional Configuration

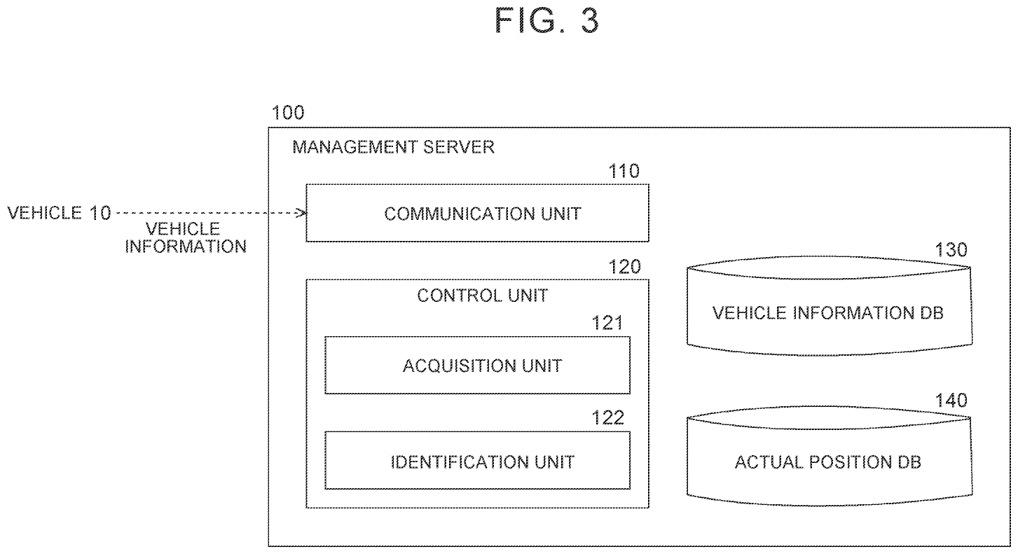

Next, the functional configuration of the management server 100 will be described with reference to FIG. 3. FIG. 3 is a block diagram schematically showing an example of the functional configuration of the management server 100. Note that, according to the present embodiment, the management server 100 corresponds to an “information processing device” according to the first aspect of the present disclosure.

The management server 100 includes a communication unit 110, a control unit 120, a vehicle information database (vehicle information DB) 130, and an actual position database (actual position DB) 140 as functional units. The communication unit 110 has a function of connecting the management server 100 to the network N1. The communication unit 110 can be realized by the communication I/F 102.

The control unit 120 has a function of performing arithmetic processing for controlling the management server 100. The control unit 120 can be realized by the processor 101. Then, the control unit 120 executes a process of receiving the vehicle information transmitted from the vehicle 10 using the communication unit 110. Further, the control unit 120 executes a process of storing the vehicle information periodically received from the vehicle 10 in the vehicle information DB 130. Note that, the vehicle information DB 130 is constructed in the auxiliary storage unit 104 as the program of the database management system is executed by the processor 101.

Further, the control unit 120 includes an acquisition unit 121 and an identification unit 122. In the control unit 120, the functional units described above execute processes for identifying the actual position where the wheelchair user 20 has a record of boarding or exiting the vehicle 10.

Here, when the wheelchair user 20 boards or exits the vehicle 10, the vehicle 10 is in a stopped state and the door is open. Further, when the wheelchair user 20 boards the vehicle 10 or exits the vehicle 10, it tends to take longer than the case where a user who can walk by himself or herself boards the vehicle 10 or exits the vehicle 10. Therefore, when the wheelchair user 20 boards the vehicle 10 or exits the vehicle 10, a duration during which the door of the vehicle 10 is open tends to be longer as compared with the case where the user who can walk by himself or herself boards the vehicle 10 or exits the vehicle 10. Therefore, the wheelchair user 20 can be determined to have boarded or exited the vehicle 10 based on the length of the duration during which the door of the vehicle 10 is open while the vehicle 10 is stopped.

Therefore, the acquisition unit 121 acquires the vehicle information of the vehicle 10 stored in the vehicle information DB 130. Then, based on the vehicle information, the identification unit 122 identifies, as the actual position, the position of the vehicle 10 when the door of the vehicle 10 is open for a predetermined period or more while the vehicle 10 is stopped.

At this time, the identification unit 122 determines that the vehicle 10 is in a stopped state when the speed of the vehicle 10 is 0 and the position of the shift lever is at the parking position in the state information included in the vehicle information. Further, the identification unit 122 derives the length of the duration during which the door is open based on the date and time information included in the vehicle information when the open or closed state of the door indicates that the door is open in the state information included in the vehicle information. That is, when the speed of the vehicle 10 is 0, the position of the shift lever is at the parking position, and the duration during which the open or closed state of the door indicates that the door is open continues for a predetermined period or longer in the state information, the identification unit 122 determines the position of the vehicle 10 in the position information as the actual position. Note that, the predetermined period is a period that is assumed to be necessary for the wheelchair user 20 to board or exit the vehicle 10. Note that, as information indicating that the vehicle 10 is in a stopped state, the state information other than the speed of the vehicle 10 and the position of the shift lever may be used.

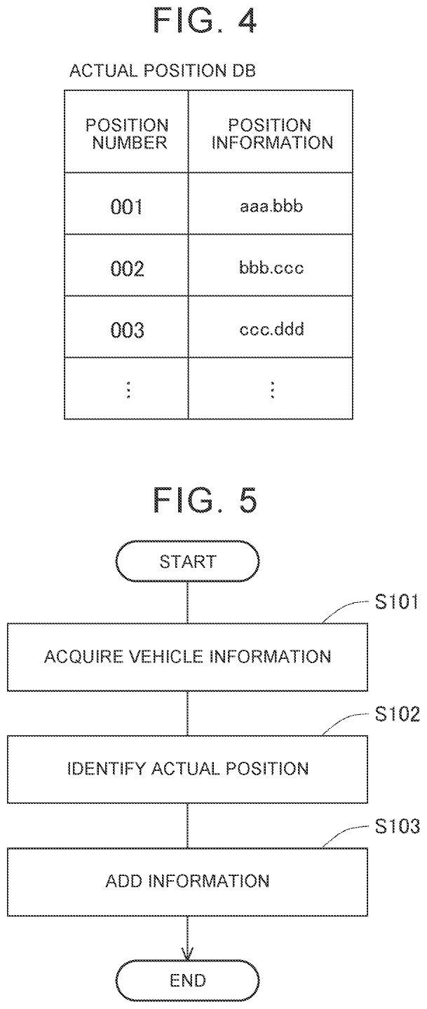

Then, the control unit 120 adds the information on the actual position identified by the identification unit 122 to the actual position DB 140. FIG. 4 is a diagram showing an example of a table configuration of the actual position DB 140. As shown in FIG. 4, the position number for each actual position and the position information are entered in the actual position DB 140. In addition, the position number is a number assigned to each actual position each time the actual position information is added to the actual position DB 140. Note that, the actual position DB 140 is also constructed in the auxiliary storage unit 104 in the same manner as the vehicle information DB 130.

### Information Processing

Next, a flow of processes executed to update the actual position DB 140 in the management server 100 will be described with reference to FIG. 5. FIG. 5 is a flowchart showing the flow of processes executed to update the actual position DB 140. This flow is repeatedly executed by the control unit 120 of the management server 100 at predetermined intervals.

In this flow, first, in S101, the vehicle information of the vehicle 10 stored in the vehicle information DB 130 is acquired. Next, in S102, the actual position is identified based on the vehicle information acquired in S101. Next, in S103, the information of the actual position identified in S102 is added to the actual position DB 140. With this, the information stored in the actual position DB 140 is updated. Note that, when the vehicle information is transmitted from the vehicles 10 to the management server 100, this flow is executed with the vehicle field information of each vehicle 10 as a target.

According to the present embodiment, it is possible to generate the actual position DB 140 in which the actual positions where the wheelchair user 20 has a record of boarding or exiting the vehicle 10 are accumulated. This makes it possible to generate a database of suitable positions for wheelchair users to board or exit the vehicle.

### Modification

Here, a modification of the present embodiment will be described. In this modification, the vehicle 10 is provided with a slope device. The slope device is a device used when the wheelchair user 20 boards or exits the vehicle 10. In the vehicle 10, when the wheelchair user 20 boards or exits the vehicle 10, the slope device is pulled out from a vehicle body and used. At this time, pulling out of the slope device from the vehicle body is controlled by the ECU 11.

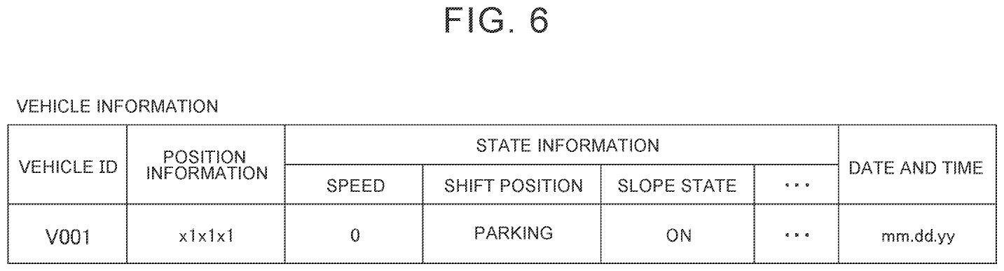

FIG. 6 is a diagram showing an example of a table configuration of vehicle information transmitted from the vehicle 10 to the management server 100 in the present modification. As shown in FIG. 6, in the vehicle information according to the present modification, information related to the usage state (slope state) of the slope device is input as one data item of the state information. Note that, the information in the vehicle information other than the information related to the usage state of the slope device is the same as the vehicle information shown in FIG. 2.

In the present modification, the wheelchair user 20 can be determined to have boarded or exited the vehicle 10 based on the usage state of the slope device in the vehicle 10. Therefore, the identification unit 122 identifies the position of the vehicle 10 when the slope device is used in the vehicle 10 as the actual position based on the vehicle information acquired from the vehicle information DB 130. Also in the present modification, the control unit 120 adds the information on the actual position identified by the identification unit 122 to the actual position DB 140.

In the present modification, the slope device corresponds to a “wheelchair device” according to the present modification. However, the “wheelchair device” is not limited to the slope device, and may be any device used when the wheelchair user boards or exits the vehicle.

### Second Embodiment

### System Configuration

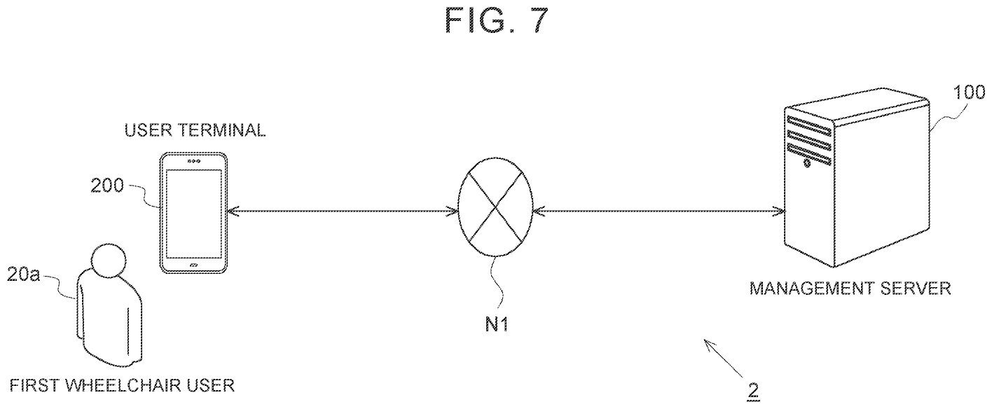

FIG. 7 is a diagram showing a schematic configuration of an information management system according to the present embodiment. An information management system 2 is a system that provides information on positions suitable for a wheelchair user to board or exit a vehicle. Here, a case where the information management system 2 provides information on the position suitable for a wheelchair user to board the vehicle will described as an example.

In the present embodiment, in the information management system 2, the management server 100 is connected to a user terminal 200 via the network N1. The management server 100 is a server device that is the same as the management server 100 in the information management system 1 according to the first embodiment. Therefore, the management server 100 includes the actual position DB 140 in which a plurality of actual positions is stored.

However, the management server 100 is not necessarily shared between the information management system 1 and the information management system 2. That is, the management servers in the information management systems 1 and 2 may be separate devices as long as the actual position DB 140 provided in the management server 100 in the information management system 1 can be used by the management server of the information management system 2. Note that, according to the present embodiment, the management server 100 corresponds to an “information processing device” according to the second aspect of the present disclosure.

The user terminal 200 is a terminal owned by a first wheelchair user 20a. In FIG. 7, the first wheelchair user 20a is a wheelchair user who desires to board the vehicle. The user terminal 200 transmits user information to the management server 100 via the network N1. The user information at this time includes the current position information of the user terminal 200 as information on a desired boarding position of the first wheelchair user 20a. Note that, the desired boarding position does not necessarily have to be the current position of the user terminal 200. For example, the first wheelchair user 20a may input the desired boarding position to the user terminal 200. In the present embodiment, the user terminal 200 corresponds to a “user terminal” according to the present disclosure.

When the management server 100 receives the user information from the user terminal 200, the management server 100 executes a process of proposing a boarding position to the first wheelchair user 20a. Specifically, in the management server 100, the control unit 120 executes a process of receiving the user information transmitted from the user terminal 200 using the communication unit 110. Further, the control unit 120 executes a process of proposing a boarding position suitable for the first wheelchair user 20a to board the vehicle based on the user information.

### Information Processing

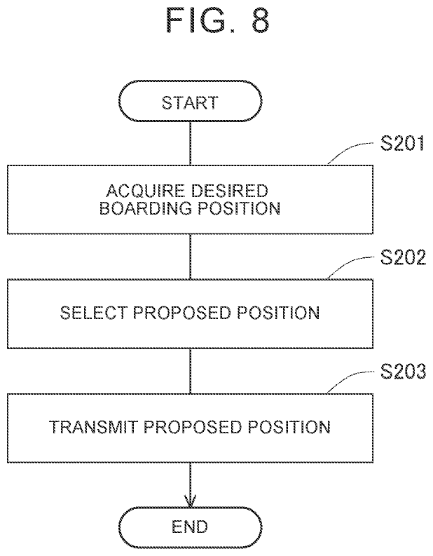

Here, a flow of processes executed in the management server 100 to propose the boarding position to the first wheelchair user 20a will be described with reference to FIG. 8. FIG. 8 is a flowchart showing the flow of processes executed to propose the boarding position to the first wheelchair user 20a. This flow is executed by the control unit 120 of the management server 100 when the management server 100 receives the user information from the user terminal 200.

In this flow, first, in S201, information on the desired boarding position of the first wheelchair user 20a included in the user information received from the user terminal 200 is acquired. Next, in S202, the boarding position to be proposed to the first wheelchair user 20a is selected from the actual positions stored in the actual position DB 140 based on the information on the desired boarding position acquired in S201. At this time, the control unit 120 selects a position within a predetermined range from the desired boarding position from the actual positions as the boarding position to be proposed to the first wheelchair user 20a. Note that, when the actual positions are present within the predetermined range from the desired boarding position, the actual position closer to the desired boarding position may be preferentially selected. Next, in S203, information on the boarding position to be proposed to the first wheelchair user 20a selected in S202 is transmitted to the user terminal 200.

According to the above flow, the position in the vicinity of the desired boarding position of the first wheelchair user 20a that has been used by the wheelchair user for boarding (or exiting) the vehicle in the past can be proposed to the first wheelchair user 20a as the boarding position. That is, it is possible to propose, to the first wheelchair user 20a, a boarding position suitable for the first wheelchair user 20a to board the vehicle.

### First Modification

### System Configuration

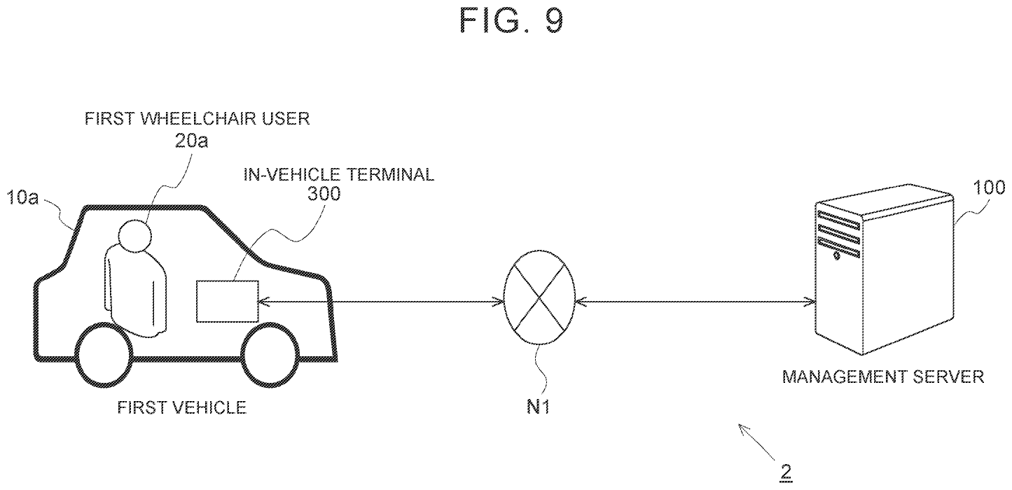

Next, a modification of the present embodiment will be described. FIG. 9 is a diagram showing a schematic configuration of an information management system according to the present modification. Here, a case where the information management system 2 provides information on the position suitable for a wheelchair user to exit the vehicle will described as an example.

In the present modification, in the information management system 2, the management server 100 is connected to an in-vehicle terminal 300 via the network N1. The in-vehicle terminal 300 is a terminal mounted on a first vehicle 10a on which the first wheelchair user 20a is on board. In FIG. 9, the first wheelchair user 20a is a user who desires to exit the first vehicle 10a. The in-vehicle terminal 300 transmits user information to the management server 100 via the network N1. The user information at this time includes the current position information of the first vehicle 10a as information on a desired exiting position of the first wheelchair user 20a. The desired exiting position does not necessarily have to be the current position of the first vehicle 10a. For example, the first wheelchair user 20a may input the desired exiting position to the in-vehicle terminal 300. Further, when the first vehicle 10a is a UD taxi, the driver of the first vehicle 10a may input the desired exiting position of the first wheelchair user 20a to the in-vehicle terminal 300. In the present modification, the in-vehicle terminal 300 corresponds to a “vehicle terminal” according to the present disclosure. However, the “vehicle terminal” is not limited to the in-vehicle terminal 300. For example, the “vehicle terminal” may be a driver terminal possessed by the driver of the first vehicle 10a.

When the management server 100 receives the user information from the in-vehicle terminal 300, the management server 100 executes a process of proposing an exiting position to the first wheelchair user 20a. Specifically, in the management server 100, the control unit 120 executes a process of receiving the user information transmitted from the in-vehicle terminal 300 using the communication unit 110. Further, the control unit 120 executes a process of proposing an exiting position suitable for the first wheelchair user 20a to exit the first vehicle 10a based on the user information.

### Information Processing

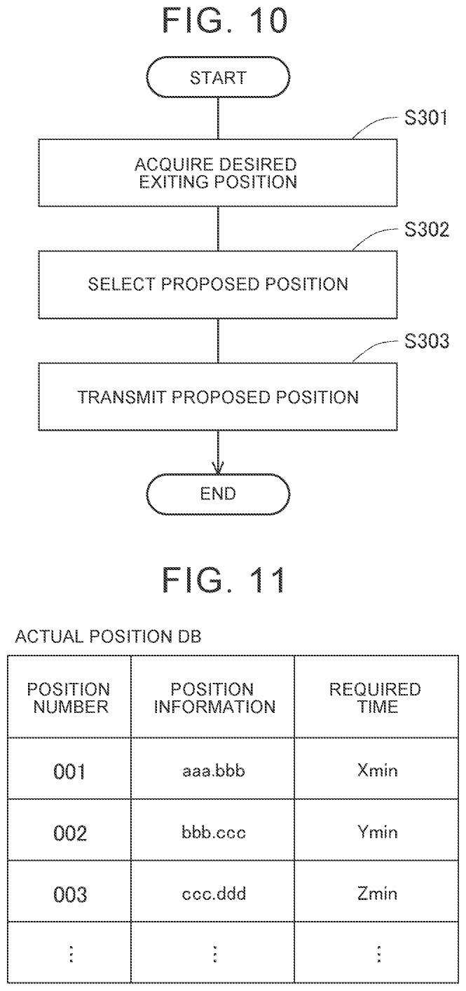

Here, a flow of processes executed in the management server 100 to propose the exiting position to the first wheelchair user 20a will be described with reference to FIG. 10. FIG. 10 is a flowchart showing a flow of processes executed to propose the exiting position to the first wheelchair user 20a. This flow is executed by the control unit 120 of the management server 100 when the management server 100 receives the user information from the in-vehicle terminal 300.

In this flow, first, in S301, information on the desired exiting position of the first wheelchair user 20a included in the user information received from the in-vehicle terminal 300 is acquired. Next, in S302, the exiting position to be proposed to the first wheelchair user 20a is selected from the actual positions stored in the actual position DB 140 based on the information on the desired exiting position acquired in S301. The method of selecting the exiting position at this time is the same as the method of selecting the boarding position executed in S202 of the flow shown in FIG. 8. Next, in S303, information on the exiting position to be proposed to the first wheelchair user 20a selected in S302 is transmitted to the in-vehicle terminal 300.

According to the above flow, the position in the vicinity of the desired exiting position of the first wheelchair user 20a that has been used by the wheelchair user for exiting (or boarding) the vehicle in the past can be proposed to the first wheelchair user 20a as the exiting position. That is, it is possible to propose, to the first wheelchair user 20a, an exiting position suitable for the first wheelchair user 20a to exit the first vehicle 10a.

### Second Modification

As described above, in the information management system 2, the management server 100 selects the boarding position or the exiting position to be proposed to the first wheelchair user 20a (hereinafter, may be referred to as a “proposed position”) from the actual positions stored in the actual position DB 140 based on the desired boarding position or the desired exiting position of the first wheelchair user 20a. Specifically, the actual position within the predetermined range from the desired boarding position or the desired exiting position of the first wheelchair user 20a is selected as the proposed position. At this time, when there are actual positions within the predetermined range from the desired boarding position or the desired exiting position, the actual position that is preferentially selected as the proposed position may be determined based on information other than the position information.

As an example, the actual position that is preferentially selected as the proposed position may be determined based on the time required for the wheelchair user to board or exit the vehicle when the wheelchair user has boarded or exited the vehicle at each actual position in the past (hereinafter, may be simply referred to as “required time”). FIG. 11 is a diagram showing a modification of the table configuration of the actual position DB 140 in the management server 100. The actual position DB 140 shown in FIG. 11 stores information on the required time for each actual position.

At this time, when the actual position DB 140 is updated, the length of the duration during which the vehicle door is open while the vehicle is in the stopped state may be stored as the required time for each actual position in the state information included in the vehicle information. Further, when the state information of the vehicle information includes information on the usage state of the slope device as in the modification of the first embodiment, the length of the usage period of the slope device may be stored as the required time for each actual position when the actual position DB 140 is updated.

Here, when the wheelchair user boards or exits the vehicle at a certain place, it is considered that the required time becomes shorter as the place is more suitable for the wheelchair user to board or exit the vehicle. Therefore, from the actual positions stored in the actual position DB 140, the actual position where the required time is relatively short can be determined to be a position more suitable for the wheelchair user to board or exit the vehicle.

Therefore, when there are the actual positions within the predetermined range from the desired boarding position or the desired exiting position, the management server 100 may preferentially select the actual position where the required time stored in the actual position DB 140 is shorter than the other as the proposed position. With this configuration, the boarding position or the exiting position that is more suitable for the wheelchair user to board or exit the vehicle can be proposed to the first wheelchair user 20a.

### Third Modification

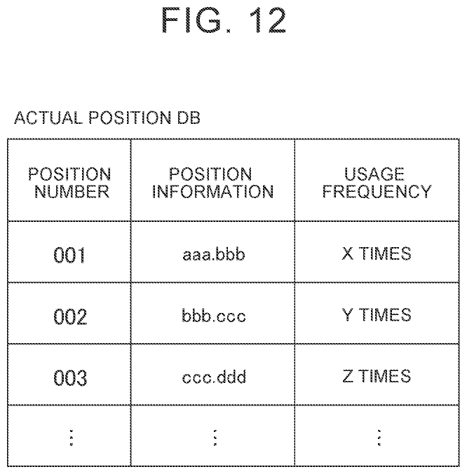

As another example, the actual position that is preferentially selected as the proposed position may be determined based on a frequency that the wheelchair user has boarded or exited the vehicle at each actual position in the past (hereinafter, may be simply referred to as “usage frequency”). FIG. 12 is a diagram showing another modification of the table configuration of the actual position DB 140 in the management server 100. The actual position DB 140 shown in FIG. 12 stores information on the usage frequency for each actual position. At this time, when the actual position DB 140 is updated in the case where the wheelchair user boards or exits the vehicle a plurality of times at the same actual position, the number of times indicating the usage frequency for the actual position is added.

Here, it is considered that as a certain place is more suitable for the wheelchair user to board or exit the vehicle, the usage frequency at the place is considered to become high. Therefore, from the actual positions stored in the actual position DB 140, the actual position where the usage frequency is relatively high can be determined to be a position more suitable for the wheelchair user to board or exit the vehicle.

Therefore, when there are the actual positions within the predetermined range from the desired boarding position or the desired exiting position, the management server 100 may preferentially select the actual position where the usage frequency stored in the actual position DB 140 is higher than the other as the proposed position. Also with this configuration, the boarding position or the exiting position that is more suitable for the wheelchair user to board or exit the vehicle can be proposed to the first wheelchair user 20a.

### Fourth Modification

Further, as another example, the actual position that is preferentially selected as the proposed position may be determined based on the traffic volume around each actual position. A place of which traffic volume is relatively small is considered to be more suitable for the wheelchair user to board or exit the vehicle than a place of which traffic volume is relatively large. Therefore, the management server 100 acquires information on the surrounding traffic volume for each actual position present within the predetermined range from the desired boarding position or the desired exiting position. Then, the management server 100 may preferentially select the actual position where the traffic volume in the vicinity is less than the other as the proposed position. Also with this configuration, the boarding position or the exiting position that is more suitable for the wheelchair user to board or exit the vehicle can be proposed to the first wheelchair user 20a.

### Other Embodiments

The above-described embodiments are merely examples, and the present disclosure may be appropriately modified and implemented without departing from the scope thereof. For example, the processes and means described in the present disclosure can be free combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiments, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc read-only memory (CD-ROM), digital versatile disc (DVD), Blu-ray disc, etc.), a read-only memory (ROM), a random access memory (RAM), an erasable programmable read-only memory (EPROM), an electrically erasable programmable read only memory (EEPROM), a magnetic card, a flash memory, or any type of medium suitable for storing electronic commands such as an optical card.

1. An information processing device comprising a control unit that executes:
acquisition of vehicle information including position information of a vehicle and state information of the vehicle;
identification of an actual position where a wheelchair user has a record of boarding or exiting the vehicle based on the vehicle information; and
addition of information on the actual position to a database.

2. The information processing device according to claim 1, wherein:
the state information includes information indicating that the vehicle is in a stopped state and information indicating that a door of the vehicle is in an open state; and
the control unit identifies, as the actual position, a position of the vehicle when the door of the vehicle is open for a predetermined period or longer while the vehicle is in the stopped state.

3. The information processing device according to claim 1, wherein:
the state information includes information indicating a usage state of a wheelchair device used when the wheelchair user boards or exits the vehicle; and
the control unit identifies, as the actual position, a position of the vehicle when the wheelchair device is used.

4. An information processing device comprising:
a database that stores information on a plurality of actual positions where a wheelchair user has a record of boarding or exiting a vehicle; and
a control unit, wherein the control unit
acquires information on a desired boarding position or a desired exiting position of a first wheelchair user; and
selects a boarding position or an exiting position to be proposed to the first wheelchair user from the actual positions stored in the database based on the desired boarding position or the desired exiting position.

5. The information processing device according to claim 4, wherein the control unit selects a position within a predetermined range from the desired boarding position or the desired exiting position as the boarding position the exiting position to be proposed to the first wheelchair user from the actual positions.

6. The information processing device according to claim 4, wherein:
information related to a required time for the wheelchair user to board or exit the vehicle when the wheelchair user boards or exits the vehicle at each of the actual positions in the past is stored in the database; and
the control unit selects the boarding position or the exiting position to be proposed to the first wheelchair user from the actual positions based on the required time at each of the actual positions.

7. The information processing device according to claim 6, wherein the control unit preferentially selects the actual position where the required time is shorter than the other as the boarding position or the exiting position to be proposed to the first wheelchair user.

8. The information processing device according to claim 4, wherein:
information related to a frequency that the wheelchair user boards or exits the vehicle at each of the actual positions in the past is stored in the database; and
the control unit selects the boarding position or the exiting position to be proposed to the first wheelchair user from the actual positions based on the frequency at each of the actual positions.

9. The information processing device according to claim 8, wherein the control unit preferentially selects the actual position where the frequency is higher than the other as the boarding position or the exiting position to be proposed to the first wheelchair user.

10. The information processing device according to claim 4, wherein the control unit selects the boarding position or the exiting position to be proposed to the first wheelchair user from the actual positions based on information related to a traffic volume around each of the actual positions.

11. The information processing device according to claim 10, wherein the control unit preferentially selects the actual position where the traffic volume around the actual position is smaller than the other as the boarding position or the exiting position to be proposed to the first wheelchair user.

12. The information processing device according to claim 4, wherein the control unit
receives information on the desired boarding position of the first wheelchair user from a user terminal possessed by the first wheelchair user, and
transmits information on the boarding position to be proposed to the first wheelchair user to the user terminal.

13. The information processing device according to claim 12, wherein the control unit receives current position information of the user terminal as the information on the desired boarding position of the first wheelchair user.

14. The information processing device according to claim 4, wherein the control unit
receives information on the desired exiting position of the first wheelchair user from a vehicle terminal related to a first vehicle that the first wheelchair user is on board, and
transmits information on the exiting position to be proposed to the first wheelchair user to the vehicle terminal.

15. The information processing device according to claim 14, wherein the control unit receives current position information of the first vehicle as the information on the desired exiting position of the first wheelchair user.

16. An information processing method executed by a computer, the method comprising:
acquiring information on a desired boarding position or a desired exiting position of a first wheelchair user; and
selecting a boarding position or an exiting position to be proposed to the first wheelchair user from a plurality of actual positions where a wheelchair user has a record of boarding or exiting a vehicle that is stored in a database based on the desired boarding position and the desired exiting position.

17. The information processing method according to claim 16, wherein a position within a predetermined range from the desired boarding position or the desired exiting position is selected as the boarding position or the exiting position to be proposed to the first wheelchair user from the actual positions.

18. The information processing method according to claim 16, wherein:
information related to a required time for a wheelchair user to board or exit the vehicle when the wheelchair user boards or exits the vehicle at each of the actual positions in the past is stored in the database; and
the boarding position or the exiting position to be proposed to the first wheelchair user is selected from the actual positions based on the required time at each of the actual positions.

19. The information processing method according to claim 16, wherein:
information related to a frequency that a wheelchair user boards or exits the vehicle at each of the actual positions in the past is stored in the database; and
the boarding position or the exiting position to be proposed to the first wheelchair user is selected from the actual positions based on the frequency at each of the actual positions.

20. The information processing method according to claim 16, wherein the boarding position or the exiting position to be proposed to the first wheelchair user is selected from the actual positions based on information related to a traffic volume around each of the actual positions.
